(19) United States
(12) Patent Application Publication
(10) Pub. No.: US 2017/0044346 A1
(43) Pub. Date: Feb. 16, 2017

(54) PROCESS FOR MAKING PELLET PRODUCT FOR USE IN SOIL NEUTRALIZATION AND OTHER APPLICATIONS

(71) Applicant: John Hinton Waters, Chatsworth, GA (US)

(72) Inventor: John Hinton Waters, Chatsworth, GA (US)

(21) Appl. No.: 15/259,444

(22) Filed: Sep. 8, 2016

Related U.S. Application Data
(63) Continuation-in-part of application No. 14/826,353, filed on Aug. 14, 2015.

(51) Int. Cl. C08J 11/06; A01K 1/015; C09K 17/40; C08L 95/00; C09K 8/035

(52) U.S. Cl. CPC C08J 11/06; C08L 95/00; C09K 8/035; C09K 17/40; A01K 1/0152; A01K 1/0154; A01K 1/0155; C08L 2207/20; C08J 2300/30

(57) ABSTRACT

Recycled carpet mineral filler material is processed to form pellets that can be used in a variety of applications, such as an agricultural lime product, an asphalt paving additive, a loss control material, or cat litter. Used carpet undergoes a shredding process separating valuable resin fibers from the mineral filler and the residual glue. The mineral filler/residual glue undergoes a screening process and then a pelletizing process to produce an agricultural lime product. A liquid or dry adhesive binder can be added to facilitate compaction of the mineral filler in such a manner as to form a pellet, which reduces dust and increases the ease of handling.

### CROSS REFERENCE TO RELATED APPLICATIONS

This application is a continuation-in-part of U.S. patent application Ser. No. 14/826,353, filed Aug. 14, 2015 and which is incorporated herein by reference.

### TECHNICAL FIELD AND BACKGROUND OF INVENTION

The present invention relates to a process utilizing recycled carpet filler to produce a pellet product that can be used in various applications. One embodiment of the invention comprises a process for making a pellet product for use in soil neutralization. Another embodiment of the invention comprises a process for making a cat litter product.

The recycling of used carpet is common today. Typically, the recycling of used carpet involves shredding the used carpet into pieces and separating reusable carpet fibers from the carpet adhesive and adhesive components, such as filler material. The adhesive material generated from carpet recycling has generally had minimal economic value and is therefore disposed of as waste, typically by being land filled.

Disposing the adhesive material in landfills can be economically and environmentally costly. Accordingly, it would be desirable to adapt the adhesive material for a productive use having the potential to generate economic value from the adhesive material rather than having to incur the costs of land filling the material. Calcium carbonate and magnesium carbonate are commonly used as filler materials in carpet adhesives. These materials can also be components of agricultural lime products used for soil neutralization. However, current carpet recycling methods typically reduce these adhesive filler materials to a fine powder that is unsuitable for use in agricultural lime products.

### SUMMARY OF INVENTION

Accordingly, one object of the present invention is to provide a process in which adhesive material generated from the recycling of used carpet is adapted for an economically beneficial application. Another object of the present invention is to provide a method in which carpet adhesive filler material from recycled used carpet is adapted for use as an agricultural lime product for soil neutralization. These and other objects of the invention can be achieved in various embodiments of the invention described below.

A method of making a soil neutralization pellet according to an embodiment of the invention comprises providing a waste powder generated from recycled used carpet, and compressing the waste powder with a binding agent adapted for facilitating compression of the waste powder into pellets adapted for use in soil neutralization.

According to another embodiment of the invention, the waste powder comprises calcium carbonate and/or magnesium carbonate.

According to another embodiment of the invention, the waste powder comprises an adhesive.

According to another embodiment of the invention, the adhesive comprises a mineral filler comprised of calcium carbonate or magnesium carbonate.

According to another embodiment of the invention, the waste powder comprises latex.

According to another embodiment of the invention, the used carpet is shredded and separated into a first mixture comprising the waste powder and a second mixture comprising reusable carpet fibers.

According to another embodiment of the invention, the waste powder comprises an adhesive and an adhesive filler material from the used carpet. The adhesive filler material comprises calcium carbonate and/or magnesium carbonate.

According to another embodiment of the invention, the binding agent comprises water, lignum, paraffin wax, polypropylene, acrylic, and/or polyethylene.

According to another embodiment of the invention, the pellets have a size of − 1/2 inch to +50 mesh.

A method of making an agricultural lime pellet for use in soil neutralization according to an embodiment of the invention comprises providing a used carpet material comprising reusable carpet fibers, adhesive and adhesive filler material, shredding the used carpet material, and separating the used carpet material into a first mixture comprising the reusable carpet fibers and a second mixture comprising a waste powder comprising the adhesive and the adhesive filler material. The waste powder is compressed into pellets to produce a pelletized agricultural lime product adapted for use in soil neutralization.

According to another embodiment of the invention, the pellets have a size of − 1/2 inch to +50 mesh.

According to another embodiment of the invention, the waste powder is mixed with a binding agent adapted for facilitating compression of the waste powder into pellets to produce a pelletized agricultural lime product adapted for use in soil neutralization.

According to another embodiment of the invention, the waste powder is positioned on a rotating disc while the binding agent is applied to the waste powder on the rotating disc, such that the waste powder is formed into the pelletized agricultural lime product. The binding agent can be water, lignum, paraffin wax, polypropylene, acrylic, or polyethylene.

According to another embodiment of the invention, the waste powder is positioned between two rollers that compact the waste powder into the pelletized agricultural lime product.

Another embodiment of the invention comprises an agricultural lime pellet for use in soil neutralization made by a process in which used carpet material is shredded and reusable carpet fibers are separated from the carpet adhesive material. The separated adhesive material is compressed into an agricultural lime pellet adapted for use in soil neutralization.

According to another embodiment of the invention, the pellet comprises calcium carbonate, and has a size of − 1/2 inch to +50 mesh.

Another embodiment of the invention comprises a process that compacts/compresses/densifies/pelletizes the loose adhesive waste powders derived from the shredding and separation process of used carpet to produce a usable pelletized product with substantially reduced fugitive dust emissions, allows much easier handling and greatly improved broadcast characteristics,

Another embodiment of the invention comprises a cat litter pellet made by a process used carpet material is shredded and the reusable carpet fibers are separated from the adhesive material. The adhesive material is compressed into a dense piece, such as a sheet, and the dense piece is formed into a pellet that can be used as cat litter.

According to another embodiment of the invention, the cat litter pellet has a size of +1 millimeter to −6 millimeter mesh.

According to another embodiment of the invention, the dense piece is granulated into smaller pieces, and the smaller pieces are screened to produce pellets having a size of about +1 millimeter to −6 millimeter mesh.

Another embodiment of the invention comprises an asphalt paving additive. The additive is made by a process in which used carpet material is shredded and reusable fibers are separated from the carpet adhesive material. The adhesive material is compressed into a dense piece, such as a sheet, and the dense piece is formed into a pellet that can be used as an asphalt paving additive.

According to another embodiment of the invention, the dense piece is granulated into smaller pieces, which are screened to produce pellets having a median particle size of less than 15% −100 US mesh to less than 1% +14 US mesh.

Another embodiment of the invention comprises a fluid loss control additive that minimizes unintended loss of a fluid, such as in the oil and gas industry. The additive is made by a process in which used carpet material is shredded and reusable fibers are separated from the carpet adhesive material. The adhesive material is compressed into a dense piece, such as a sheet, and the dense piece is formed into a pellet that can be used as an asphalt paving additive.

According to another embodiment of the invention, the dense piece is granulated into smaller pieces, which are screened to produce pellets having a median particle size of less than 15% −100 US mesh to less than 1% +14 US mesh.

### BRIEF DESCRIPTION OF THE DRAWINGS

FIG. 1 is a schematic flow diagram illustrating a process for making an agricultural lime product according to a preferred embodiment; and

FIG. 2 is a perspective view of soil neutralization pellets according to a preferred embodiment of the invention.

### DESCRIPTION OF PREFERRED EMBODIMENTS OF THE INVENTION AND BEST MODE

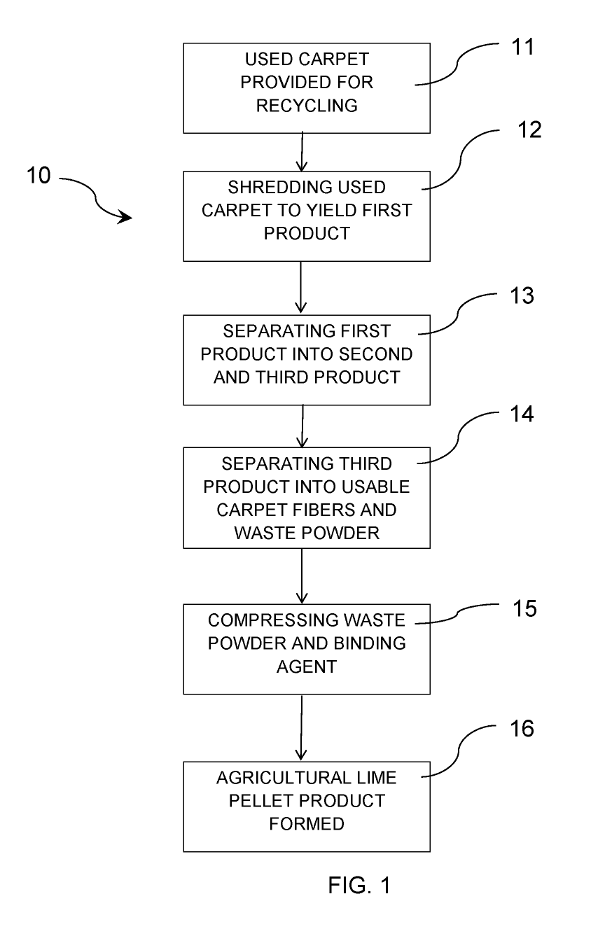

A process for making a soil neutralization product according to a preferred embodiment of the invention is illustrated in FIG. 1, and shown generally at reference numeral 10. The process comprises adapting adhesive material generated from recycled used carpet to produce a pelletized agricultural lime product for use in soil neutralization.

In the first step, shown at reference numeral 11 of FIG. 1, used carpet material that is to be recycled is provided. The used carpet material can be generally comprised of carpet fibers and adhesive material. The carpet adhesive material can be comprised of an adhesive and a mineral filler material, such as calcium carbonate (CaCO₃) or magnesium carbonate (MgCO₃). In addition, the adhesive material can include organic filler material. Typically, the organic filler constitutes 15%-35% of the adhesive material.

The second step 12 comprises shredding the used carpet material to yield a first product comprised of shredded carpet material. The third step 13 comprises separating the shredded carpet material into a second product comprised of reusable carpet fibers and a third product comprised of adhesive material and residual carpet fibers. That is, reusable carpet fibers are separated from the adhesive material comprising adhesive and adhesive filler material. If desired, the adhesive material can undergo a second separation process in a fourth step 14 of the process 10 to further separate and remove residual carpet fibers from the adhesive material. The shredding and separating steps 12, 13, 14 can be carried out via known carpet recycling methods, such as is described in U.S. Patent Application Publication 2011/0040027, which is incorporated herein by reference. For example, the separation steps 13, 14 can be carried out using screening, gravity separation, air classification, or any combination thereof. The shredding and separating steps 12, 13, 14 render the adhesive material into a loose, free flowing waste powder having a size of approximately −20 mesh to +100 mesh. That is, ninety percent or more of the waste powder particles can pass through a 20 mesh sieve and is retained by a 100 mesh sieve.

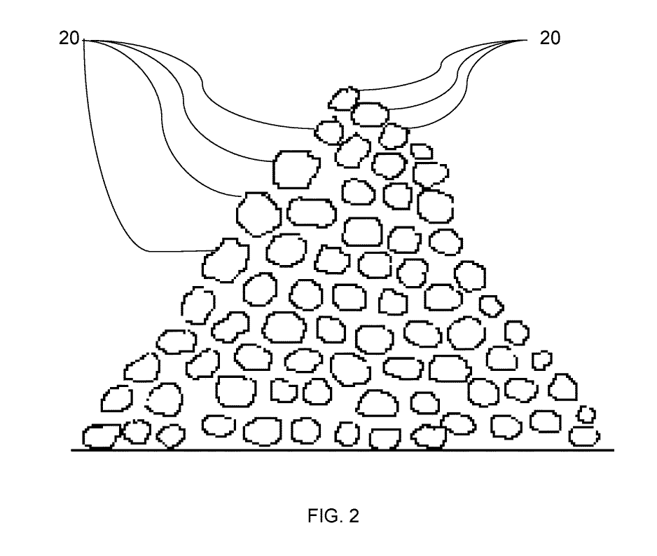

In a fifth step 15, the adhesive material waste powder is mixed and compressed into larger pellets 20, shown in FIG. 2, that are suitable for use as agricultural lime. A binding aid can be added to the waste powder during the compression step 15. The binding aid facilitates the compression of the waste powder, and helps bind the powders together to prevent the compacted powder from returning to the original powder state. The binding aid can be a liquid or solid substance that holds the compacted powder together in a longer lasting state. Liquid binding aids include water and lignum. Solid binding aids include wax, various resins, polypropylene, acrylic, and polyethylene. Preferably, the binding aid is added to and mixed with the waste powder such that the binding aid is 5%-25% of the total weight of the waste powder and binding aid mixture.

The compression step 15 can be carried out by a variety of means for compressing the powder together. The adhesive material waste powder can be compressed by moving the powder particles between two rollers which compact the waste powder particles into large dense pellets. Alternatively, the waste powder can be moved over a rotating disc while a liquid binding aid is applied to the waste powder moving on the rotating disc, causing the waste powders to lump together and form the dense sheet, flake or pellet. Alternatively, the compression step 15 can be carried out by other means such as extrusion. Optionally, the pellets formed by the compression step 15 can then be screened to a specific particle size to meet a set specification or can be used directly as is.

Preferably, the adhesive material waste powder is compressed into pellets 20 in which 98% of the pellets 20 have a size of − 1/2 inch to +50 mesh. That is, 98% or more of the pellets 20 can pass through a 1/2 inch sieve and is retained by a 50 mesh screen. The compressed pellets 20 reduce dust and increases the ease of handling. The carpet mineral filler (calcium carbonate (CaCO₃) or magnesium carbonate (MgCO₃)) contained in the pellets 20 has pH neutralizing properties. In addition, the organic compounds contained in the pellets 20 provide improved moisture retention and anti-caking properties, which are valuable soil improvement properties. As such, the pellets 20 have the chemical and physical properties suitable for use as an agricultural lime soil neutralization product.

At the end 16 of the process 10 an agricultural lime pellet 20 is formed. The process 10 produces a pelletized product 20 with drastically reduced fugitive dust emissions, allows much easier handling and broadcast characteristics are greatly improved. The process 10 produces a valuable soil improvement product 20 which provides pH neutralization, water retention, anti-caking, reduced fugitive dust and drastically improved handling and broadcast characteristics all of which produces a useable pelletized product that would otherwise be land filled.

According to another embodiment of the invention, during the compression step 15, the adhesive material waste powder is compressed into a solid dense sheet, a dense flake or a large dense pellet, the size of which exceeds the desired size specification for the pellet 20. Such dense sheet, flake or pellet is granulated into smaller pieces, and screened using various size screen openings over multiple screens to obtain a desired particle size distribution (PSD) range of the material. The range is often referred to as median particle size (MPS), which can vary from 50 mesh to 1/2 inch in MPS. Preferably, the granulated material is screened to yield pellets 20 having a median particle size range of +1 mm to −6 mm, which can be used as an agricultural lime product. That is, the pellets 20 are retained by a one millimeter (1 mm) size mesh screen, and the pellets 20 can pass through a six millimeter (6 mm) size mesh screen.

According to another embodiment of the invention, the pellets 20, having a median particle size range of +1 mm to −6 mm, can be used as cat litter. The pellets 20 are absorbent and provide an effective cat litter. The pellets 20 comprise organic adhesives (20-30% by weight), which instantly absorb liquids like a sponge. Once exposed to liquids the pellets 20 lump together facilitating the removal and cleaning of the wet pellets 20 from the litter box.

Known semi-clumping cat litter sticks are prone to stick to the cat's paws causing the cat to track litter out of the litter box. However, the pellets 20 are semi-clumping and do not aggressively stick to the cat's paws, thus greatly reducing the amount of litter carried out of the litter box. Known cat litters will stick to and build up between the cat's paws. However, the semi-clumping pellets 20 greatly reduce the buildup of particles between the cat's paws. Further, the pellets 20 are about one-third to one-half of the weight of typical clay based cat litter products, thus being more cost effective for shipping, storage and usage. The pellets 20 can provide about 33% to 50% more volume for the same amount of weight of known cat litters. Another advantage the pellets 20 provide over known clay based cat litters made from non-recycled materials is that the pellets 20 are made from recycled carpet, and as such are attractive to customers seeking “green” points for using recycled products.

According to another embodiment of the invention, the pellets 20 can be used as a loss control material (LCM) in the oil and gas industry. In such an embodiment, the granulated material is screened to yield pellets 20 preferably having a median particle size range of less than 15% −100 US mesh to less than 1% +14 US mesh. That is, less than 15% of the particles are retained by a 100 US mesh screen, and less than 1% of the particles can pass through a 14 US mesh screen.

The pellets 20 can be made from very fine non-abrasive CaCO mineral powders and adhesives. Known loss control materials are typically abrasive, causing excess wear on the drilling equipment and components. The pellets 20 of the loss control material embodiment are free flowing, and when mixed with other drilling liquids/muds the pellets 20 flow freely into the areas where pressure has been lost. Once the material freely flows into the area where the pressure is lost, the materials build up and plug the area that is losing pressure. Once the plugging begins the material readily compacts allowing higher and higher pressures. The loss control material pellets 20 provide needed compactions for the higher pressures. Oil and gas drilling and service companies today are very interested in using recycling as part of their overall “green” program, providing another benefit to using the pellets 20 as a loss control material.

According to another embodiment of the invention, the pellets 20 can be used as additives in asphalt and paving patch materials. In such an embodiment, the granulated material is screened to yield pellets 20 preferably having a median particle size range of less than 15% −100 US mesh to less than 1% +14 US mesh. The pellets 20 allow asphalts to expand and contract without cracking as the fine micronized CaCO3 minerals and the soft organic adhesive materials “absorb” expansion and contractions of the asphalt due to temperature changes, without the asphalt cracking. The use of the pellets 20 as an asphalt/paving material additive allows expensive virgin asphalts to be loaded/filled with less expensive recycled material, thereby reducing overall costs. The pellets 20 can be easily mixed in with virgin asphalt—the fine particle size of the mineral filler of the recycled pellets 20 flow easily into the virgin asphalts allowing the compounds to be efficiently mixed together. The recycled pellets 20 act as a “sponge” allowing the asphalt to be compressed and return to original size/shape. This “sponge” effect allows the material to be used in running field sports tracks, allowing better absorption and traction.

A pellet product and method of making same are described above. Various changes can be made to the invention without departing from its scope. The above description of the preferred embodiments and best mode of the invention are provided for the purpose of illustration only and not limitation—the invention being defined by the following claims and equivalents thereof.

What is claimed is:

1. A cat litter pellet made by a process comprising:
(a) providing a used carpet material comprising reusable carpet fibers and an adhesive material comprising an adhesive and a mineral filler;
(b) shredding the used carpet material and separating the reusable carpet fibers from the adhesive material;
(c) compressing the adhesive material into a dense piece; and
(d) forming the dense piece into a pellet adapted for use as cat litter.

2. The cat litter pellet according to claim 1, wherein the cat litter pellet has a size of +1 millimeter to −6 millimeter mesh.

3. The cat litter pellet according to claim 1, wherein the step of forming the dense piece into a pellet adapted for use as cat litter comprises:
(a) granulating the dense piece into smaller pieces; and
(b) screening the smaller pieces to produce a pellet having a size of +1 millimeter to −6 millimeter mesh.

4. The cat litter pellet according to claim 1, wherein the mineral filler comprises at least one selected from the group consisting of calcium carbonate and magnesium carbonate.

5. The cat litter pellet according to claim 1, wherein the step of compressing the adhesive material into a dense piece comprises mixing the adhesive material with a binding agent adapted for facilitating compression of the adhesive material.

6. The cat litter pellet according to claim 5, wherein the step of compressing the adhesive material further comprises moving the adhesive material over a rotating disc while the binding agent is applied to the adhesive material moving on the rotating disc.

7. The cat litter pellet according to claim 5, wherein the binding agent comprises at least one selected from the group consisting of water, lignum, paraffin wax, polypropylene, acrylic, and polyethylene.

8. An asphalt paving additive made by a process comprising:
(a) providing a used carpet material comprising reusable carpet fibers and an adhesive material comprising an adhesive and a mineral filler;
(b) shredding the used carpet material and separating the reusable carpet fibers from the adhesive material;
(c) compressing the adhesive material into a dense piece; and
(d) forming the dense piece into pellets adapted for use as an additive to asphalt paving.

9. The asphalt paving additive according to claim 8, wherein the pellets have a median particle size of less than 15% −100 US mesh to less than 1% +14 US mesh.

10. The asphalt paving additive according to claim 8, wherein the step of forming the dense piece into pellets adapted for use an additive to asphalt paving comprises:
(a) granulating the dense piece into smaller pieces; and
(b) screening the smaller pieces to yield pellets having a median particle size of less than 15% −100 US mesh to less than 1% +14 US mesh.

11. The asphalt paving additive according to claim 8, wherein the mineral filler comprises at least one selected from the group consisting of calcium carbonate and magnesium carbonate.

12. The asphalt paving additive according to claim 8, wherein the step of compressing the adhesive material into a dense piece comprises mixing the adhesive material with a binding agent adapted for facilitating compression of the adhesive material.

13. The asphalt paving additive according to claim 12, wherein the step of compressing the adhesive material further comprises moving the adhesive material over a rotating disc while the binding agent is applied to the adhesive material moving on the rotating disc.

14. The asphalt paving additive according to claim 12, wherein the binding agent comprises at least one selected from the group consisting of water, lignum, paraffin wax, polypropylene, acrylic, and polyethylene.

15. A fluid loss control additive for minimizing unintended loss of a fluid from an apparatus containing the fluid:
(a) providing a used carpet material comprising reusable carpet fibers and an adhesive material comprising an adhesive and a mineral filler;
(b) shredding the used carpet material and separating the reusable carpet fibers from the adhesive material;
(c) compressing the adhesive material into a dense piece; and
(d) forming the dense piece into pellets adapted for use as a fluid loss control additive.

16. The fluid loss control additive according to claim 15, wherein the pellets have a median particle size of less than 15% −100 US mesh to less than 1% +14 US mesh.

17. The fluid loss control additive according to claim 15, wherein the step of forming the dense piece into pellets adapted for use a fluid loss control additive comprises:
(a) granulating the dense piece into smaller pieces; and
(b) screening the smaller pieces to yield pellets having a median particle size of less than 15% −100 US mesh to less than 1% +14 US mesh.

18. The fluid loss control additive according to claim 15, wherein the mineral filler comprises at least one selected from the group consisting of calcium carbonate and magnesium carbonate.

19. The fluid loss control additive according to claim 15, wherein the step of compressing the adhesive material into a dense piece comprises mixing the adhesive material with a binding agent adapted for facilitating compression of the adhesive material, the binding agent comprising at least one selected from the group consisting of water, lignum, paraffin wax, polypropylene, acrylic, and polyethylene.

20. The fluid loss control additive according to claim 15, wherein the step of compressing the adhesive material further comprises moving the adhesive material over a rotating disc while the binding agent is applied to the adhesive material moving on the rotating disc.
